(19) United States
(12) Patent Application Publication
(10) Pub. No.: US 2014/0059848 A1
(43) Pub. Date: Mar. 6, 2014

(54) MOLTEN SALT BATTERY AND METHOD FOR MANUFACTURING MOLTEN SALT BATTERY

(71) Applicants: Eiichi Kobayashi, Osaka-shi (JP); Koji Nitta, Osaka-shi (JP)

(72) Inventors: Eiichi Kobayashi, Osaka-shi (JP); Koji Nitta, Osaka-shi (JP)

(73) Assignee: SUMITOMO ELECTRIC INDUSTRIES, LTD., Osaka-shi, Osaka (JP)

(21) Appl. No.: 14/115,007

(22) PCT Filed: Dec. 21, 2012
(86) PCT No.: PCT/JP2012/083322

§ 371 Date: Oct. 31, 2013

(30) Foreign Application Priority Data
Dec. 27, 2011 (JP) 2011-285397
May 10, 2012 (JP) 2012-108246

(51) Int. Cl. H01M 10/39

(52) U.S. Cl. CPC H01M 10/399
USPC 29/623.5; 29/623.1

(57) ABSTRACT

The present invention provides a method for manufacturing a molten salt battery having a positive electrode, a negative electrode, a separator arranged between the positive electrode and the negative electrode, and an electrolyte salt, which is solid at normal temperature. The solid electrolyte salt is retained on a surface of at least one of the positive electrode, the negative electrode, and the separator prior to assembly of the battery. Then, the battery is assembled by housing the positive electrode, the negative electrode, and the separator in a battery case.

### FIELD OF THE INVENTION

The present invention relates to a molten salt battery, which is a secondary battery using a molten salt as an electrolyte and its manufacturing method. The present invention particularly relates to a method for effectively incorporating electrolyte salt into a molten salt battery.

### BACKGROUND OF THE INVENTION

Conventionally, a lithium-ion secondary battery, which is a non-aqueous electrolyte secondary battery, has been widely used as a power source for portable appliances such as cell phones, laptops, and digital cameras. In addition, the lithium-ion secondary battery has been recently drawing attention as a large-sized and large-capacity battery for electric drive vehicles such as electric automobiles and electric motorcycles and for hybrid automobiles.

However, the lithium-ion secondary battery has the following drawbacks.

First, the applications of the lithium-ion secondary battery are also spreading in the areas of automobiles and electric power storage or the like, in addition to portable appliances. In this situation, there are problems of capacity for supplying lithium resources.

Second, common lithium-ion secondary batteries employ combustible organic electrolytes. Thus, when a part of a battery heats or ignites, thermal runaway may occur in the entire battery, and improvement in safety of the battery is desired.

In recent years, a sodium-ion secondary battery using a molten salt as an electrolyte has been developed as a new-type battery, which remedies the above-mentioned problems of the lithium-ion secondary battery (Non-patent Document 1).

The sodium-ion secondary battery (hereinafter, referred to as molten salt battery) using molten salt as the electrolyte employs sodium, which is more abundant than lithium on earth. Furthermore, since a molten salt battery uses an incombustible molten salt as an electrolyte, thermal runaway is not caused even if a part of the battery heats or ignites. Therefore the battery has excellent safety.

Molten salts have excellent properties such as non-volatility, incombustibility, and high ionic concentration. Molten salts are usually maintained at a high temperature to keep a molten state. A molten salt having a melting point of less than 100° C. is also called ionic liquid.

Recently, it was demonstrated that a molten salt battery having a high energy density and high safety could be constituted by using a molten salt having a low melting point of 57° C. (mixture of NaFSA and KFSA*¹) (Non-patent Document 1). *1: NaFSA (sodium bis(fluorosulfonyl)amide) KFSA (potassium bis(fluorosulfonyl)amide)

In the process for manufacturing this molten salt battery, the electrolyte salt is conventionally injected into the battery in a state of molten salt. That is, after the power generating elements such as a positive electrode, a negative electrode, and a separator are incorporated into the battery, the battery body and the electrolyte salt are heated to a temperature higher than a melting point of the electrolyte salt. Then, the molten salt is injected into the battery body. This manipulation allows the molten salt to infiltrate the power generating elements such as the positive electrode, the negative electrode, and the separator to form electrolyte.

### PRIOR ART DOCUMENT

### Non-Patent Document

Non-patent Document 1: Electrochemistry, 80 (2), 98-103 (2012)

### SUMMARY OF THE INVENTION

However, since the molten salt electrolyte may have a relatively high viscosity, it is difficult to uniformly diffuse and infiltrate the molten salt electrolyte hardly diffuses into the power generating elements of the battery. Hence, the molten salt electrolyte does not sufficiently infiltrate through the power generating elements at some parts. In addition, regarding a molten salt battery having a large-sized electrode or a wide electrode, a large amount of time, facilities and labor work are often required for aging treatment to ensure infiltration of the molten salt electrolyte.

The objective of the present invention is to provide a method for manufacturing an effective molten salt battery that solves problems that accompany the above described method for injecting molten salt and is capable of uniformly forming a certain amount of molten salt electrolyte with high reproducibility.

The present inventors conducted intensive studies and found that the step of injecting the molten salt into a battery case could be eliminated and the above problems could be solved by a method in which an electrolyte salt being solid at normal temperature was used as an electrolyte, the solid electrolyte salt was retained in at least one of electrodes and a separator before the electrodes and the separator were housed in the battery case, at least one of the electrodes and the separator retaining the solid electrolyte salt was put in the battery case, and the battery was assembled.

Namely, the present invention relates to a manufacturing method of the following molten salt battery and to the molten salt battery.

In accordance with one aspect of the present invention a method for manufacturing a molten salt battery having a positive electrode, a negative electrode, a separator arranged between the positive electrode and the negative electrode, and an electrolyte salt that is solid at normal temperature is provided. The method includes retaining solid electrolyte salt on a surface of at least one of the positive electrode, the negative electrode, and the separator prior to assembly of the battery, and assembling the battery by housing the positive electrode, the negative electrode, and the separator in a battery case.

The retaining solid electrolyte salt on a surface of at least one of the positive electrode, the negative electrode, and the separator may be coating the surface with a powdery electrolyte salt.

The retaining solid electrolyte salt on a surface of at least one of the positive electrode, the negative electrode, and the separator may be heating the solid electrolyte salt to render the electrolyte salt semisolid or liquid and applying the semisolid or liquid electrolyte salt on the surface.

The application may conducted by spraying.

The retaining solid electrolyte salt on a surface of at least one of the positive electrode, the negative electrode, and the separator may be conducted by heating the solid electrolyte salt to form a molten salt and by immersing at least one of the positive electrode, the negative electrode, and the separator in the molten salt and then pulling it up.

Excess molten salt on at least one of the positive electrode, the negative electrode, and the separator may be removed by applying oscillation, air spray or centrifugation to at least one of the pulled positive electrode, the negative electrode, and the separator.

The retaining the solid electrolyte salt on a surface of at least one of the positive electrode, the negative electrode, and the separator may be conducted by overlaying the solid electrolyte salt formed into a plate on the surface.

A molten salt battery is also provided that is manufactured by the above described method for manufacturing a molten salt battery.

According to the method of the present invention, a step of pouring electrolyte liquid into a battery case can be eliminated in the manufacturing method of the molten salt battery. As a result, the manufacturing steps can be simplified, which reduces the production costs and improves production efficiency.

According to the method of the present invention, a certain amount of molten salt electrode can be uniformly formed with high reproducibility, and thus performance and quality of the molten salt battery are stabilized.

Additionally, a part of the electrolyte material may be incorporated into the battery by the method of the present invention, and the remaining part of the electrolyte material may be incorporated into the battery by the conventional molten salt injecting method. Such a method combining the method of the present invention and the molten salt injecting method is effective for allowing the molten salt electrolyte to quickly and uniformly diffuse and infiltrate the battery.

### BRIEF DESCRIPTION OF THE DRAWINGS

FIG. 1 is a cross-sectional view illustrating a basic constitution of a molten salt battery;

FIG. 2 is a cross-sectional view illustrating an example of a configuration of a laminated molten salt battery; and

FIG. 3 is a perspective view illustrating an example of a configuration of a rolled molten salt battery.

### DETAILED DESCRIPTION OF THE PREFERRED EMBODIMENTS

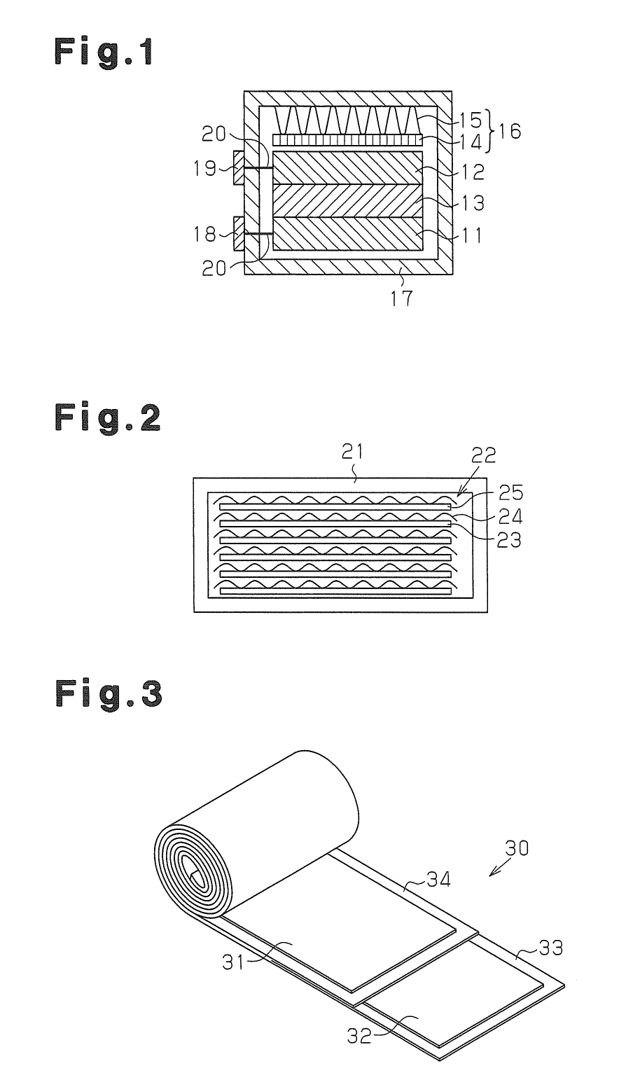

Hereinafter, molten salt batteries according to embodiments of the present invention will be described with reference to FIGS. 1 to 3.

A molten salt battery shown in FIG. 1 basically has a positive electrode 11, which is formed by a positive-electrode current collector with a surface supporting a positive-electrode active material, a negative electrode 12, which is formed by a negative-electrode current collector with a surface supporting a negative-electrode active material, a separator 13 impregnated with electrolyte salt, and a battery case 17 housing the positive electrode 11, the negative electrode 12, and the separator 13. A pressing member 16, which is formed by a presser plate 14 and a spring 15 for pressing the presser plate 14, is placed between an upper face of the battery case 17 and the negative electrode. Even when the volumes of the positive electrode 11, the negative electrode 12, and the separator 13 are changed, the positive electrode 11 and the negative electrode 12 are kept in contact with the separator 13 by the pressure applied through the pressing member 16. The positive-electrode current collector and the negative-electrode current collector are connected with a positive terminal 18 and a negative terminal 19, respectively, through leads 20. The separator may be a microporous film made of polyethylene or polypropylene.

As the electrolyte of the molten salt battery in the present invention, various inorganic and organic salts that are solid at normal temperature and melt at an operating temperature of the battery can be used. As cations of the electrolyte salt, one or more types selected from alkali metals such as sodium (Na), potassium (K), lithium (Li), rubidium (Rb) and cesium (Cs), and alkaline earth metals such as beryllium (Be), magnesium (Mg), calcium (Ca), strontium (Sr) and barium (Ba) can be used. As anions of the electrolyte salt, FSA (bis(fluorosulfonyl)amide), TFSA (bis(trifluoromethylsulfonyl)amide), BETA (bis(pentafluoroethylsulfonyl)amide) and the like can be used.

In order to lower the melting point of the electrolyte salt, two or more salts are preferably mixed for use. For example, when KFSA (K—N(SO₂F)₂; potassium bis(fluorosulfonyl)amide) is used in combination with NaFSA (Na—N(SO₂F)₂; sodium bis(fluorosulfonyl) amide), the melting point is lowered to an eutectic temperature of 61° C., and therefore the operating temperature of the battery can be set at 90° C. or lower.

The separator is used for physically preventing the positive electrode and the negative electrode from directly contacting each other. As the separator, a nonwoven glass fabric, a porous plastic or the like can be used. The separator is impregnated with the molten salt. The positive electrode, the negative electrode, and the separator impregnated with the electrolyte salt are laminated and housed in the battery case. In this case, the electrolyte salt impregnating the separator melts at the operating temperature of the battery, and is diffused and distributed in both of the positive and negative electrodes contacting the separator.

FIG. 2 is a cross-sectional view of the molten salt battery in which an electrode laminate 22 formed by laminating positive plates 23, separators 24, and negative plates 25 arranged in this order is housed in a battery case 21. Although not illustrated, a positive tab is provided on each end of each positive plate 23. A positive lead is connected to each positive tab. In addition, a negative tab is provided on each end of each negative plate 25. A negative lead is connected to each negative tab. These leads are drawn out from the battery case 21. The electrolyte salt is enclosed in the battery case 21.

FIG. 3 is a perspective view of an electrode laminate formed by rolling an elongated electrode. In FIG. 3, a rolled electrode laminate 30 is formed by a positive electrode 31, a negative electrode 32, a separator 33, and a separator 34. The separator 33, the negative electrode 32, the separator 34, and the positive electrode 31 are laminated in this order, rolled, then flattened by applying pressure, and housed in the battery case. Although not illustrated, a positive tab and a negative tab are connected to the positive electrode 31 and the negative electrode 32, respectively. The electrolyte salt is enclosed in the battery case housing the rolled electrode laminate.

Next, as methods for manufacturing a molten salt battery according to embodiments of the present invention, methods for manufacturing the laminated molten salt battery shown in FIG. 2 will be described. These embodiments are, however, exemplary, the present invention is not limited by these embodiments, and the scope of the invention is represented by the claims. Equivalents of the inventions described in the claims and all modifications within the scope of the claims are included in the scope of the present invention.

### Embodiment 1

In this embodiment, a powdery electrolyte salt is used. The powdery electrolyte salt can be obtained, for example, by crushing a massive electrolyte salt with a pulverizer or by spraying molten salt to a cold space to solidify it.

The powdery electrolyte salt is spread on the surface of a first separator horizontally laid. Then, a first electrode (negative or positive electrode) is laid on the separator, and the powdery electrolyte salt is spread on the surface of the first electrode. Then, a second separator is laid on the first electrode, and the powdery electrolyte salt is spread on the surface of the second separator. Then, a second electrode (positive or negative electrode) is laid on the second separator, and the powdery electrolyte salt is spread on the surface of the second electrode. Subsequently, the same process is repeated to obtain an electrode laminate with a desired number of layers.

In another method, powdery electrolyte salt is dissolved in a general organic solvent to prepare a solution, the solution is used to produce an electrode, and then the organic solvent is removed by evaporation in a drying step of the electrode. Alternatively, a solution prepared by dissolving powdery electrolyte salt in a general organic solvent is applied to surfaces of electrodes and a separator (hereinafter referred to as electrodes and the like), and the organic solvent is removed by evaporation in a drying step of the electrodes and the like.

In the method using the solution prepared by dissolving powdery electrolyte salt in a general organic solvent, it is also effective to add a binder together with the electrolyte salt to the organic solvent.

Subsequently, the electrode laminate in which the electrodes and the separators both retaining the powdery electrolyte salt are laminated is housed in a battery case, and then the battery case is sealed.

The surfaces of the electrodes and the like retaining the electrolyte salt may be only outer surfaces of the positive electrode, the negative electrode, and the separator, only the inner surfaces, or both of the outer and inner surfaces.

In a case where the electrolyte salt is dissolved in the organic solvent for use or a case where the electrolyte salt itself is melted for use, a solid electrolyte salt can be easily retained on the inner surfaces of the electrodes and the like.

### Embodiment 2

In this embodiment, a semisolid or liquid electrolyte salt is used. Semisolid electrolyte salt can be obtained by heating the above described powdery electrolyte salt to an extent that it is not completely dissolved. That is, the semisolid means a solid-liquid mixture state with a relatively high viscosity including a semi-coagulated state. In addition, the liquid electrolyte salt can be obtained by melting the electrolyte salt through heating. The electrolyte salt can also be rendered semisolid by adjusting the formulation of each component in the electrolyte salt.

The semisolid or liquid electrolyte salt is applied to the surfaces of the electrodes and the like by any application means such as a brush, an application roller, a rolling coater, a bar coater, a doctor blade, a wire bar, a screen, and a discharger. In this case, it is not necessary to apply the electrolyte salt to the whole surfaces of the electrodes and the like. For example, the electrolyte salt may be applied in a form of lines, belts, a lattice, multiple dots or the like. In these cases, the electrolyte salt is applied such that it is uniformly dispersed to the application surface.

Subsequently, an electrode laminate is formed using the electrodes and the like to which the electrolyte salt is applied, and the laminate is housed in the battery case, then the battery case is sealed.

### Embodiment 3

In this embodiment, the semisolid or liquid electrolyte salt is applied to the surfaces of the electrodes and the like by using a spraying device. The amount of application can be controlled by adjusting the temperature of the electrolyte salt, the amount and time of spray.

Subsequently, an electrode laminate is formed using the electrodes and the like to which the electrolyte salt is applied, and the laminate is housed in the battery case, then the battery case is sealed.

### Embodiment 4

In this embodiment, molten salt electrolyte is put in an immersion bath, in which the electrodes and the like are immersed, pulled up and then cooled, so that the electrolyte salt adheres to the surfaces of the electrodes and the like, which is in turn impregnated with the electrolyte salt.

The amounts of adhering and impregnation of the electrolyte salt can be controlled by adjusting the temperature of the molten salt electrolyte and the formulation of each component in the molten salt electrolyte.

In impregnation, a vacuum impregnation apparatus is preferably used. The electrodes and the like may be immersed one by one in the molten salt electrolyte. Alternatively, they may be immersed in the molten salt electrolyte after two or more sheets are laminated. In addition, the electrodes and the like pulled up after immersing may be stuck with excess molten salt electrolyte. The excess molten salt electrolyte can be removed by applying any of oscillation, centrifugation, pressurization or air spray to the electrodes and the like.

Subsequently, an electrode laminate is formed using the electrodes and the like with the adhered and impregnated electrolyte salt, and the laminate is housed in the battery case, then the battery case is sealed.

### Embodiment 5

In this embodiment, a plate-like electrolyte salt is used. The plate-like electrolyte salt can be obtained, for example, by applying molten salt electrolyte on a support sheet and solidifying it. The layer of the plate-like electrolyte salt on a support sheet is overlaid the electrodes and the like, such that the layer of this electrolyte salt is brought into direct contact with the surfaces of the electrodes and the like. Then, the support sheet is removed, thereby the plate-like (layered) electrolyte salt can be retained on the surfaces of the electrodes and the like.

Subsequently, an electrode laminate is formed using the electrodes and the like and housed in the battery case, then the battery case is sealed.

The electrolyte salt, the positive electrode, the negative electrode, and the separator material are likely to adsorb moisture in the manufacturing step of the molten salt battery. However, the adsorption of moisture may lower performance of the molten salt battery. Thus, it is desirable that the manufacturing step of the molten salt battery be conducted in an inert gas such as nitrogen and argon or in dry air so that moisture adsorption is unlikely to occur.

### EXAMPLES

### Example 1

### (Production of Negative Electrode)

A negative-electrode current collector in which a zinc (Zn) sputter film with a thickness of 130 nm was formed on a surface of a 10 cm×10 cm aluminum (Al) piece with a thickness of 20 μm was used. In charging, sodium (Na), which transferred from the positive electrode, precipitated on the negative-electrode current collector.

### (Production of Positive Electrode)

As a positive-electrode current collector, a 10 cm×10 cm Al current collector with a thickness of 20 μm was used.

As a positive-electrode active material, NaCrO₂ was used. In addition, an acetylene black was used as a conductive aid, and PVDF was used as a binder.

The positive-electrode active material, the conductive aid and the binder were mixed in a ratio of 85:10:5, to which N-methyl-2-pyrrolidone (NMP) was added as necessary to render the mixture pasty. The paste was applied to the Al current collector, dried, and pressed such that its thickness was 50 μm to obtain a positive electrode.

### (Electrolyte Salt)

As the electrolyte salt, a mixture in which NaFSA and KFSA were mixed in a ratio of 1:1 was used.

### (Separator)

As the separator, a microporous polypropylene film with a thickness of 50 μm was used.

### (Production of Electrode Laminate)

Powdery electrolyte salt was spread on the surface of a first separator. Then, a negative electrode was laid on the first separator, and the powdery electrolyte salt was spread on the surface of the negative electrode. Then, a second separator was laid on this negative electrode, and the powdery electrolyte salt was spread on the surface of the second separator. Then, the positive electrode was laid on the second separator, and the powdery electrolyte salt was spread on the surface of the positive electrode. Thus, the electrode laminate retaining the electrolyte salt was produced.

### (Production of Battery)

The electrode laminate produced as described above was housed in the battery case, and the battery case was sealed to produce batteries, having 10 cells in total.

### (Evaluation of Batteries)

From the initial period, when charging and discharging were conducted while heating the whole battery to the temperature of 90° C., a 100% capacity of the total battery capacity was obtained in any of the batteries of this example. In contrast, in a molten salt battery with ten cells produced by the conventional molten salt-injecting method, the battery capacity was increased as the cycles of charging and discharging were repeated, and thus an average of approximately six cycles were required for reaching to the maximum capacity.

Additionally, the battery of this example had smaller variation in the discharging capacity and showed about 3% higher discharging capacity compared to the battery produced by the molten salt-injecting method.

In relation to these two batteries, a charging/discharging cycle test was continuously conducted in the same condition, and performance of cycle life was studied. The cycle life was defined as the number of the cycles until the battery capacity was lowered to 20% of the initial capacity. As a result, the battery of the present invention showed a cycle life that was one and half times longer than that of the battery produced by the molten salt-injecting method.

### Example 2

The powdery electrolyte salt in Example 1 was heated to render it semisolid, and the semisolid electrolyte was applied to a separator, a negative electrode, and a positive electrode by a brush. Other than that, batteries were produced in the same way as Example 1.

The obtained batteries were evaluated in the same way as Example 1. As a result, these batteries showed the same properties as in Example 1.

### Example 3

The electrolyte salt in Example 1 was heated to render it liquid, and the liquid electrolyte salt was applied to a separator, a negative electrode, and a positive electrode by a spraying device. Other than that, batteries were produced in the same way as Example 1.

The obtained batteries were evaluated in the same way as Example 1. As a result, these batteries showed the same properties as in Example 1.

### Example 4

The electrolyte salt in Example 1 was put in an impregnation bath of a vacuum impregnation apparatus and heated to render it liquid. A separator, a negative electrode, and a positive electrode were immersed in the liquid electrolyte salt. Then, they were laminated to produce an electrode laminate. Other than that, batteries were produced in the same way as Example 1.

The obtained batteries were evaluated in the same way as Example 1. As a result, these batteries showed the same properties as in Example 1.

### Example 5

The electrolyte salt in Example 1 was put in an impregnation bath of a vacuum impregnation apparatus and heated to render it liquid. An electrode laminate made by repeatedly layering separators, negative electrodes, separators, and positive electrodes was immersed in the liquid electrolyte salt and then pulled up, thereby the electrolyte salt was retained on the electrodes and the like. Other than that, batteries were produced in the same way as Example 1.

The obtained batteries were evaluated in the same way as Example 1. As a result, these batteries showed the same properties as in Example 1.

### Example 6

The molten salt electrolyte in Example 1 was rendered semisolid, and this was applied to a surface of a fluoroplastic sheet by a brush to form a layer of the electrolyte salt. The layer of the electrolyte salt was laid on the surfaces of a separator, a negative electrode, and a positive electrode. The fluoroplastic sheet was then removed, so that the layer of the molten salt electrolyte was retained on the electrodes and the like. Other than that, batteries were produced in the same way as Example 1.

The obtained batteries were evaluated in the same way as Example 1. As a result, these batteries showed the same properties as in Example 1.

### Reference Example 1

The electrode laminate produced in Example 1 was housed in a battery case. Furthermore, the molten salt electrolyte was injected into the battery case. Then the battery case was sealed. Other than that, batteries were produced in the same way as Example 1.

The obtained batteries were evaluated in the same way as Example 1. As a result, these batteries showed the same properties as in Example 1.

1. A method for manufacturing a molten salt battery having a positive electrode, a negative electrode, a separator arranged between the positive electrode and the negative electrode, and an electrolyte salt that is solid at normal temperature, the method comprising:
retaining solid electrolyte salt on a surface of at least one of the positive electrode, the negative electrode, and the separator prior to assembly of the battery, and
assembling the battery by housing the positive electrode, the negative electrode, and the separator in a battery case.

2. The method for manufacturing a molten salt battery according to claim 1, wherein the retaining solid electrolyte salt on a surface of at least one of the positive electrode, the negative electrode, and the separator is coating the surface with a powdery electrolyte salt.

3. The method for manufacturing a molten salt battery according to claim 1, wherein the retaining solid electrolyte salt on a surface of at least one of the positive electrode, the negative electrode, and the separator is heating the solid electrolyte salt to render the electrolyte salt semisolid or liquid and applying the semisolid or liquid electrolyte salt on the surface.

4. The method for manufacturing a molten salt battery according to claim 3, wherein the application is conducted by spraying.

5. The method for manufacturing a molten salt battery according to claim 1, wherein the retaining solid electrolyte salt on a surface of at least one of the positive electrode, the negative electrode, and the separator is conducted by heating the solid electrolyte salt to form a molten salt and by immersing at least one of the positive electrode, the negative electrode, and the separator in the molten salt and then pulling it up.

6. The method for manufacturing a molten salt battery according to claim 5, wherein excess molten salt on at least one of the positive electrode, the negative electrode, and the separator is removed by applying oscillation, air spray or centrifugation to at least one of the pulled positive electrode, the negative electrode, and the separator.

7. The method for manufacturing a molten salt battery according to claim 1, wherein the retaining the solid electrolyte salt on a surface of at least one of the positive electrode, the negative electrode, and the separator is conducted by overlaying the solid electrolyte salt formed into a plate on the surface.

8. (canceled)
